(19) United States
(12) Patent Application Publication
(10) Pub. No.: US 2022/0309339 A1
(43) Pub. Date: Sep. 29, 2022

(54) INFORMATION PROCESSING DEVICE, METHOD FOR SETTING HIDDEN NODES, AND METHOD FOR MANUFACTURING INFORMATION PROCESSING DEVICE

(71) Applicant: TDK CORPORATION, Tokyo (JP)

(72) Inventors: Yukio TERASAKI, Tokyo (JP); Kazuki NAKADA, Tokyo (JP)

(73) Assignee: TDK CORPORATION, Tokyo (JP)

(21) Appl. No.: 17/496,934

(22) Filed: Oct. 8, 2021

(30) Foreign Application Priority Data
Mar. 25, 2021 (JP) PCT/JP2021/012533

(51) Int. Cl. G06N 3/08; G06N 3/063; G06N 3/04

(52) U.S. Cl. CPC G06N 3/08; G06N 3/063; G06N 3/04

(57) ABSTRACT

An information processing device includes a reservoir layer, and a read-out layer. The reservoir layer includes a plurality of nodes that generate a feature space including information of an input signal input to the reservoir layer, the read-out layer performs an operation of applying a connection weight to each of signals sent from the reservoir layer, and the number of signals sent to the read-out layer from the reservoir layer is smaller than the number of the plurality of nodes.

### CROSS-REFERENCE TO RELATED APPLICATION

This application is based upon and claims the benefit of priority from PCT International Application PCT/JP2021/012533, Mar. 25, 2021, the entire contents of which are incorporated herein by reference.

### BACKGROUND

### Field of the Invention

The present invention relates to an information processing device, a method for setting hidden nodes, and a method for manufacturing the information processing device.

### Description of Related Art

A neuromorphic device is an element that mimics the human brain by using a neural network. The neuromorphic device artificially mimics the relationship between neurons and synapses in the human brain.

A neuromorphic device has, for example, hierarchically arranged nodes (neurons in the brain) and transmission means (synapses in the brain) that connects the nodes. In a neuromorphic device, learning is performed by the transmission means (synapses) and the percentage of correct answers to questions is increased. The learning is for finding knowledge that can be utilized in the future from information, and the neuromorphic device weights input data.

As one type of neural network, a recurrent neural network is known. A recurrent neural network includes recursive coupling therein and can handle time-series data. Time-series data is data of which values change over time, and stock prices and the like are examples thereof. A recurrent neural network can also have a nonlinear activation part therein. Processing in the activation part can be mathematically regarded as a projection onto a nonlinear space. By projecting data onto a nonlinear space, the recurrent neural network can extract the characteristics of complex signal changes of time-series signals. A recurrent neural network can implement recursive processing by returning a processing result in neurons in a layer of a subsequent stage to neurons in a layer of a previous stage. A recurrent neural network can acquire rules or dominant factors behind time-series data by performing recursive processing.

Reservoir computing is a type of recurrent neural network including recursive coupling and nonlinear activation functions. Reservoir computing is a neural network developed as an implementation method for a liquid state machine.

Reservoir computing is roughly divided into a reservoir layer and a read-out layer. The “layer” herein is a conceptual layer and a layer does not have to be formed as a physical structure. The reservoir layer forms a graph structure including a large number of nonlinear nodes and recursive coupling between the nodes. In many cases, the read-out layer is composed of a single-layer perceptron. In reservoir computing, the reservoir layer mimics the neuron connections of the human brain and expresses the state as a transition of an interference state.

The characteristics of reservoir computing are that the reservoir layer is not a learning target and learning is performed only by the read-out layer. Reservoir computing requires a small amount of calculation necessary for learning and can also be implemented even with little computer resources. Therefore, reservoir computing is attracting attention as it may be applied to the Internet of things (IoT) having a limitation in hardware resources or a system that handles time-series signals at the edge.

In recent years, research has been conducted to incorporate reservoir computing into physical devices. Ryosho Nakane, Gouhei Tanaka, and Akira Hirose, IEEE Access Vol. 6 2018 pp. 4462-4469 discloses a reservoir element using a spin wave as a physical device research example.

### SUMMARY

(1) An information processing device according to a first aspect includes a reservoir layer; and a read-out layer, wherein the reservoir layer includes a plurality of nodes that generate a feature space including information of an input signal input to the reservoir layer, the read-out layer performs an operation of applying a connection weight to each of signals sent from the reservoir layer, and the number of signals sent to the read-out layer from the reservoir layer is smaller than the number of the plurality of nodes.

(2) The information processing device according to the aspect may further include a connection part that connects the reservoir layer and the read-out layer. The connection part includes a plurality of terminals that connect any of the plurality of nodes to the read-out layer, and the number of the plurality of terminals is smaller than the number of the plurality of nodes.

(3) In the information processing device according to the aspect, the connection part may include a plurality of wirings. Each of the plurality of wirings connects any one of the plurality of nodes to any one of the plurality of terminals.

(4) In the information processing device according to the aspect, the connection part may include a switch. The switch switches electrical connection between the plurality of nodes and the plurality of terminals.

(5) In the information processing device according to the aspect, the switch may switch the electrical connection between the plurality of nodes and the plurality of terminals over time.

(6) In the information processing device according to the aspect, the connection part may be stacked on the reservoir layer. The connection part includes a plurality of wiring layers.

(7) In the information processing device according to the aspect, the connection part may be stacked on the reservoir layer and may cover part of the reservoir layer when viewed from a stack direction.

(8) In the information processing device according to the aspect, the reservoir layer may include a first pad connected to any one of the plurality of nodes, and the connection part may include a second pad connected to any one of the plurality of terminals and may be attached to the reservoir layer via the first pad and the second pad.

(9) In the information processing device according to the aspect, the plurality of nodes may include a hidden node not connected to the read-out layer.

(10) In the information processing device according to the aspect, the hidden node may be determined on the basis of a result obtained by analyzing a variation amount of a plurality of nodes included in a reference information processing device by a statistical method in an operation using the reference information processing device. The reference information processing device includes a reference reservoir layer having the same configuration as the reservoir layer and a reference read-out layer having the same configuration as the read-out layer, the reference reservoir layer generates a feature space including information of input signals input to the reference reservoir layer, and the reference read-out layer performs an operation of applying a connection weight to a signal sent from each node of the reference reservoir layer.

(11) In the information processing device according to the aspect, the hidden node may be determined on the basis of a statistic of a connection weight with which each of a plurality of nodes included in a reference information processing device is connected to other nodes.

(12) In the information processing device according to the aspect, the hidden node may be determined on the basis of an absolute value of a connection weight with which each of a plurality of nodes included in a reference information processing device is connected to a reference read-out layer.

(13) In the information processing device according to the aspect, the connection weight between the plurality of nodes of the reference reservoir layer and the reference read-out layer may be determined by learning including norm minimization.

(14) In the information processing device according to the aspect, the reservoir layer may have a plurality of node layers stacked in a stack direction. Each of the plurality of node layers may have any one of the plurality of nodes, and the connection part may further include a through wiring that connects any one of the plurality of terminals and any one of the plurality of nodes, and penetrates any one of the plurality of node layers.

(15) An information processing device according to a second aspect includes a reservoir layer; and a read-out layer, wherein the reservoir layer includes a plurality of nodes that generate a feature space including information of an input signal input to the reservoir layer, the read-out layer performs an operation of applying a connection weight to each of signals sent from the reservoir layer, and the number of input terminals, to which the input signal is input, is smaller than the number of the plurality of nodes.

(16) A method for setting hidden nodes according to a third aspect includes a first step of performing a prior examination; and a second step of determining the hidden nodes, wherein the first step is performed using a reference information processing device including a reference reservoir layer and a reference read-out layer, the reference information processing device generates a feature space including information of input signals in the reference reservoir layer, applies a connection weight to a signal sent from each of nodes of the reference reservoir layer to the reference read-out layer, and performs an operation of increasing a mutual information between an output value from the reference read-out layer and an ideal value, and in the second step, on the basis of a connection weight between the nodes in the reference reservoir layer after the operation in the first step, or a connection weight between the nodes in the reference reservoir layer and the reference read-out layer, it is determined whether to set which of a plurality of nodes included in the reference reservoir layer as the hidden nodes.

(17) A method for manufacturing an information processing device according to a fourth aspect includes a step of designing a reservoir layer and a read-out layer connectable to the reservoir layer; a step of performing the method for setting hidden nodes according to the aspect by using a reference reservoir layer having the same configuration as the reservoir layer, and setting the hidden nodes in the reservoir layer; and a step of connecting nodes, other than the hidden nodes among a plurality of nodes included in the reservoir layer, to the read-out layer.

### BRIEF DESCRIPTION OF THE DRAWINGS

FIG. 1 is a conceptual diagram of an information processing device according to a first embodiment.

FIG. 2 is a cross-sectional view of part of the information processing device according to the first embodiment.

FIG. 3 is a conceptual diagram of a reference information processing device according to the first embodiment.

FIG. 4 shows a distribution of connection weights between respective nodes and a read-out layer in the reference information processing device.

FIG. 5 shows a distribution of connection weights between respective nodes and a read-out layer in the information processing device according to the first embodiment.

FIG. 6 shows a difference in output values between an inference result when all nodes and a read-out layer are connected and an inference result when some nodes and the read-out layer are connected, in a prediction task of time-series signals.

FIG. 7 shows a distribution of another example of connection weights between respective nodes and a read-out layer in the reference information processing device.

FIG. 8 shows a distribution of another example of connection weights between respective nodes and a read-out layer in the information processing device according to the first embodiment.

FIG. 9 shows a difference in output values between an inference result when all nodes and a read-out layer are connected and an inference result when some nodes and a read-out layer are connected, in a prediction task of time-series signals.

FIG. 10 is a cross-sectional view of part of an information processing device according to a first modification.

FIG. 11 is a cross-sectional view of part of an information processing device according to a second modification.

FIG. 12 is a cross-sectional view of part of an information processing device according to a third modification.

FIG. 13 is a cross-sectional view of part of an information processing device according to a fourth modification.

FIG. 14 is a cross-sectional view of part of an information processing device according to a fifth modification.

FIG. 15 is a cross-sectional view of part of an information processing device according to a sixth modification.

FIG. 16 is a cross-sectional view of part of an information processing device according to a seventh modification.

FIG. 17 is a cross-sectional view of part of an information processing device according to an eighth modification.

FIG. 18 is a cross-sectional view of part of an information processing device according to a ninth modification.

### DESCRIPTION OF EMBODIMENTS

Hereinafter, the present embodiment will be described in detail with reference to the drawings as appropriate. In the drawings used for the following description, characteristic parts may be enlarged for the purpose of convenience in order to facilitate the understanding of characteristics, and the dimensional proportions and the like of respective components may be different from actual ones. Since materials, dimensions and the like exemplified in the following description are examples, the present invention is not limited thereto and can be appropriately modified and carried out within the range in which the effects of the present invention are exhibited.

It can be said that the expressive capability of reservoir computing increases as the number of nodes included in a reservoir layer increases. On the other hand, a signal is sent from each of the nodes included in the reservoir layer to a read-out layer, resulting in an increase in the communication load and calculation load of the signal. Furthermore, in the case of a physical element, the number of terminals and wirings responsible for electric connections for signal communication significantly increases.

The present invention has been made to solve the above problems and provides an information processing device suitable for practical use, a method for setting hidden nodes, and a method for manufacturing the information processing device.

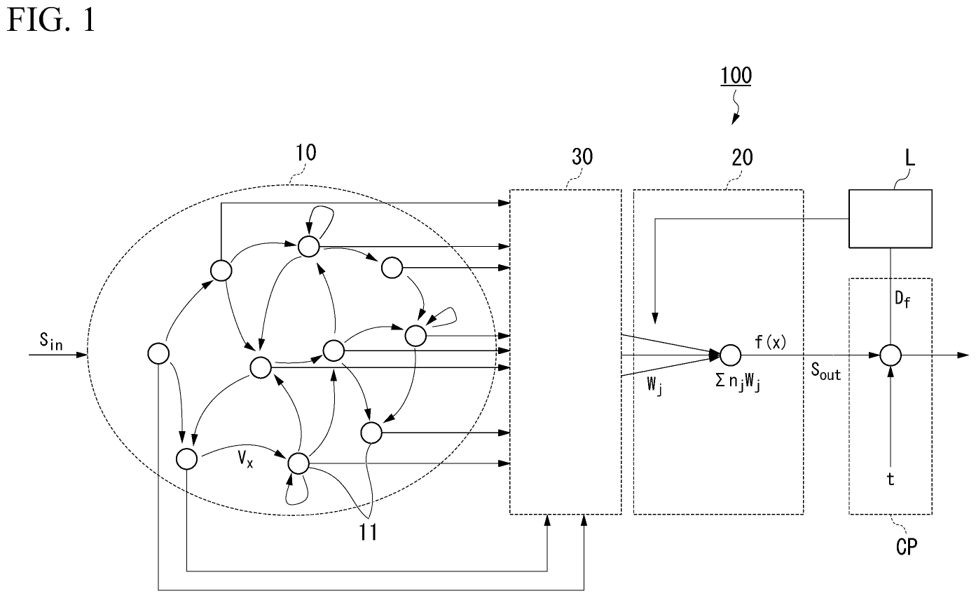

FIG. 1 is a conceptual diagram of an information processing device 100 according to a first embodiment. The information processing device 100 includes, for example, a reservoir layer 10, a read-out layer 20, a connection part 30, a comparison circuit Cp, and a learner L. The information processing device 100 can perform learning that increases the percentage of correct answers to a task, and operation (inference) that outputs an answer to the task on the basis of a learning result. The comparison circuit Cp and the learner L are used in a learning stage and are unnecessary in an inference stage.

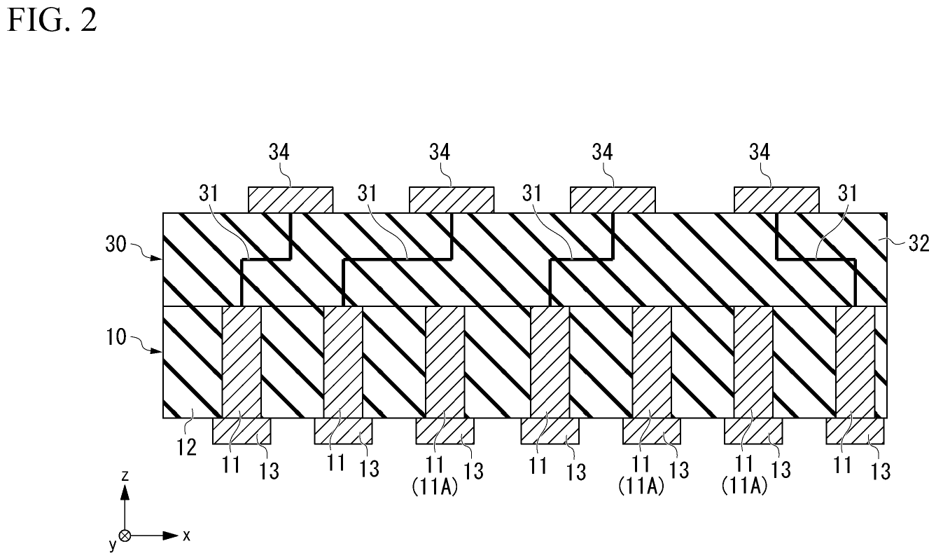

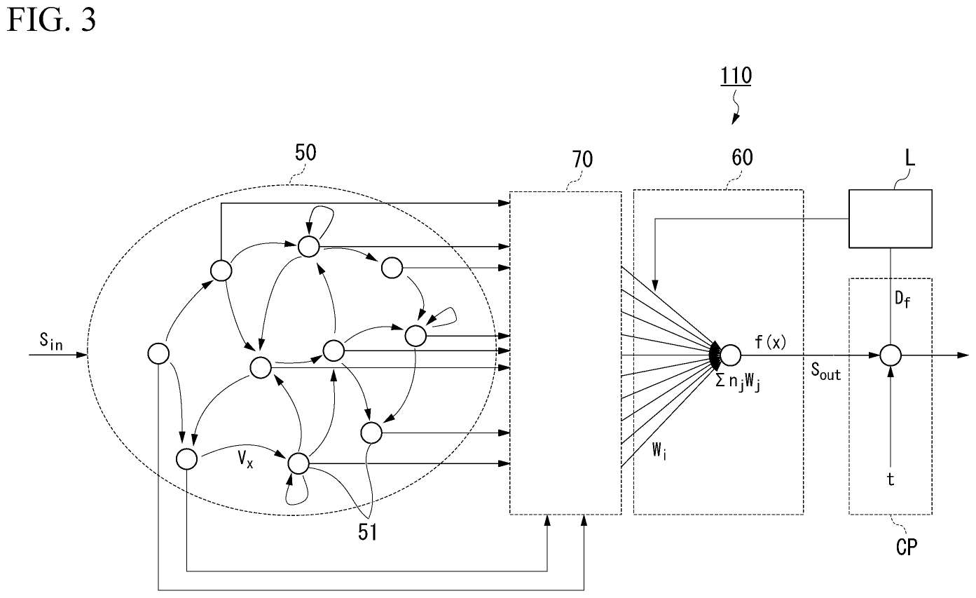

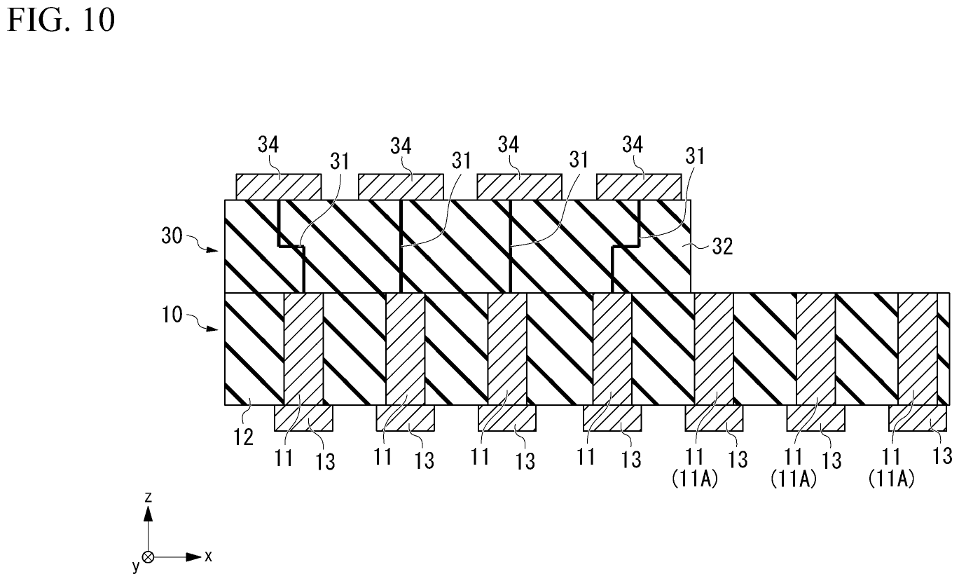

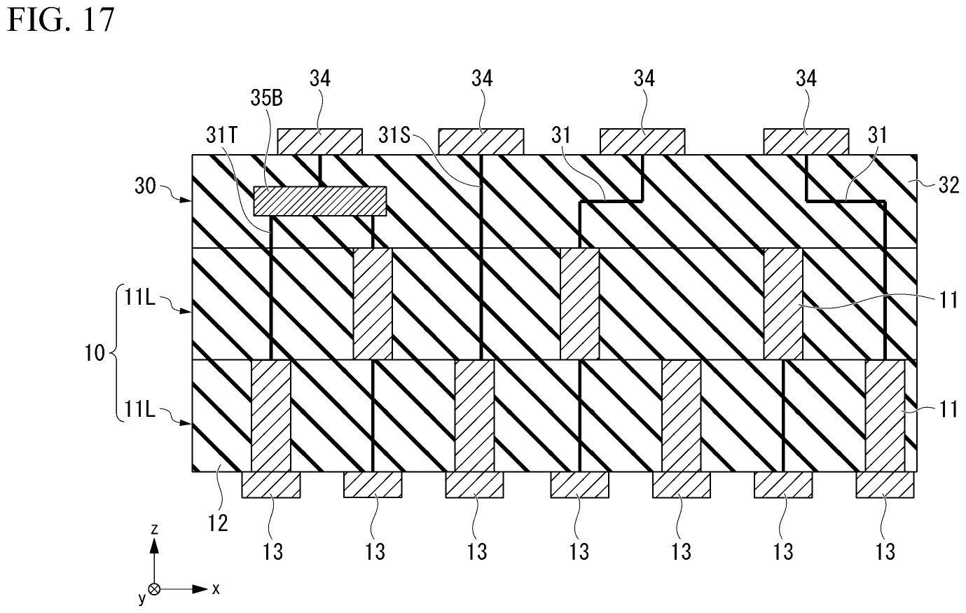

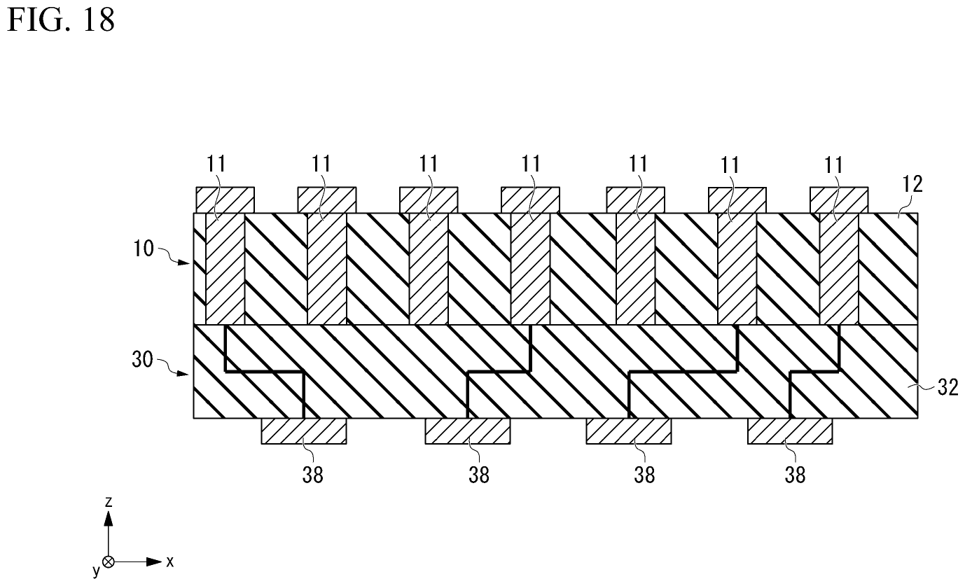

In the present specification, the “layer” may represent a “layer” as a physical structure and a “layer” as a concept. For example, in FIG. 1 and the conceptual diagram of FIG. 3 to be described below, the “layer” means a conceptual layer, and in FIG. 2, FIG. 10 to FIG. 15, FIG. 17, and FIG. 18 to be described below, the “layer” means a “layer” as a structure.

The reservoir layer 10 includes a plurality of nodes 11. The number of nodes 11 does not particularly matter. As the number of nodes 11 increases, the expressive capability of the reservoir layer 10 increases. For example, it is assumed that the number of nodes 11 is i. i is an arbitrary natural number.

Each of the nodes 11 is replaced with a physical device, for example. The physical device is, for example, a device capable of converting an input signal into a vibration, an electromagnetic field, a magnetic field, a spin wave, and the like. The node 11 is, for example, a MEMS microphone. The MEMS microphone can convert a vibration of a vibrating membrane into an electrical signal. The node 11 may also be, for example, a spin torque oscillator (STO). The spin torque oscillator can convert an electrical signal into a high frequency signal. The node 11 may be a resistance-variable element called a memristor. As the memristor, for example, a magnetic domain wall displacement type magnetoresistance effect element, whose resistance value changes depending on the position of a magnetic domain wall, and the like have been proposed. Furthermore, the node 11 may also be a Schmitt trigger circuit having a hysteresis circuit in which an output state changes with hysteresis with respect to a change in the potential of an input signal, an operational amplifier having other nonlinear response characteristics, and the like.

The respective nodes 11 interact with surrounding nodes 11. For example, a connection weight vₓ is defined between the respective nodes 11. The number of defined connection weights vₓ is as many as the number of combinations of connections between the nodes 11. x is, for example, an arbitrary natural number. Each of the connection weights vₓ between the nodes 11 is defined in principle and does not vary depending on learning. The connection weights vₓ between the nodes 11 are arbitrary and may match or differ from each other. Some of the connection weights vₓ between the plurality of nodes 11 may vary depending on learning.

Signals Sᵢₙ are input to the reservoir layer 10. The number of input signals Sᵢₙ does not matter. The signals Sᵢₙ are input from, for example, externally provided sensors. The signals Sᵢₙ interact while propagating between the plurality of nodes 11 in the reservoir layer 10. The interaction of the signals Sᵢₙ means that a signal propagated to a certain node 11 affects a signal propagating between other nodes 11. For example, the signals Sᵢₙ are changed by the connection weight vₓ applied when the signals Sᵢₙ propagate between the nodes 11. The reservoir layer 10 projects the input signals Sᵢₙ onto a multidimensional nonlinear space.

As the signals Sᵢₙ propagate between the plurality of nodes 11, the plurality of nodes 11 generate a feature space including information of the signals Sᵢₙ input to the reservoir layer 10. In the reservoir layer 10, the input signals Sᵢₙ are replaced with other signals. At least part of information included in the input signals Sᵢₙ is held as another signal having a different form. For example, the input signals Sᵢₙ are changed nonlinearly in the reservoir layer 10. An example of such conversion includes replacement of an orthogonal coordinate system (x, y, z) with a spherical coordinate system (γ, θ, ϕ). As the input signals Sᵢₙ interact in the reservoir layer 10, the state of the system of the reservoir layer 10 changes over time.

Some of the plurality of nodes 11 are connected to the read-out layer 20 via the connection part 30. For example, among i nodes 11, j nodes 11 (j is an arbitrary natural number smaller than i) are connected to the read-out layer 20. The remaining i-j nodes 11 contribute to signal interaction in the reservoir layer 10, but are not connected to the read-out layer 20. Hereinafter, nodes 11 not connected to the read-out layer 20 are referred to as hidden nodes.

The connection part 30 is located between the reservoir layer 10 and the read-out layer 20, for example. FIG. 2 is a cross-sectional view of the reservoir layer 10 and the connection part 30 according to the first embodiment. Hereinafter, the stack direction of each layer is referred to as a z direction, one direction orthogonal to the z direction is referred to as an x direction, and a direction orthogonal to the z direction and the x direction is referred to as a y direction.

The reservoir layer 10 includes the plurality of nodes 11, an insulating layer 12, and a plurality of terminals 13. The plurality of terminals 13 are connected to the nodes 11, respectively. The terminals 13 are connected to external sensors and receive the signals Sᵢₙ from the sensors. As another embodiment, the node 11 itself may serve as a sensor whose state changes depending on an external environment. For example, devices, in which piezoelectric elements are arranged in an array, themselves serve as tactile sensors and simultaneously interact with each other. That is, the node 11 has both a function as a sensor and a function as a node in reservoir computing.

The connection part 30 connects the reservoir layer 10 and the read-out layer 20. The connection part 30 is stacked on the reservoir layer 10, for example. The connection part 30 covers, for example, the reservoir layer 10 when viewed from the z direction. The connection part 30 has, for example, a plurality of wirings 31, an insulating layer 32, and a plurality of terminals 34. The read-out layer 20 is connected to each of the plurality of terminals 34.

The plurality of wirings 31 are formed in the insulating layer 32. The wiring 31 has conductivity, and is, for example, Al, Ag, Cu, and the like. The insulating layer 32 is an interlayer insulating layer, and is, for example, silicon oxide (SiOₓ), silicon nitride (SiNₓ), silicon carbide (SiC), chromium nitride, silicon carbonitride (SiCN), silicon oxynitride (SiON), aluminum oxide (Al₂O₃), zirconium oxide (ZrOₓ), and the like.

Each of the of wirings 31 connects any one of the nodes 11 to any one of the terminals 34. A first end of the wiring 31 is connected to any one of the nodes 11. A second end of the wiring 31 is connected to any one of the terminals 34.

The number of terminals 34 is, for example, j. Each of the terminals 34 is connected to the read-out layer 20. The number of terminals 34 matches the number of signals sent to the read-out layer 20. The number j of terminals 34 is smaller than the number i of nodes 11. Among the nodes 11, nodes 11, which are not connected to the terminals 34, are referred to as hidden nodes 11A.

Signals are sent to the read-out layer 20 from the reservoir layer 10. The number j of signals sent to the read-out layer 20 from the reservoir layer 10 is smaller than the number i of nodes 11 in the reservoir layer 10.

The read-out layer 20 has, for example, a product-sum operation circuit, an activation function circuit, and an output circuit.

The product-sum operation circuit multiplies each signal sent to the read-out layer 20 from the reservoir layer 10 by a connection weight wⱼ and sums the results of the multiplication. A connection weights wⱼ are set between each of the terminals 34 and the read-out layer 20. The connection weight wⱼ varies depending on learning.

The activation function circuit puts a product-sum operation result into an activation function f(x) for operation. The activation function may not be used.

The output circuit outputs the operation result to an exterior as a signal Sₒᵤₜ. In FIG. 1, the output circuit is indicated by one output signal line; however, the present invention is not limited to such a case. The read-out layer 20 can also handle, for example, a multi-class classification problem which is an application of general machine learning. In such a case, the output circuit has a plurality of output signal lines corresponding to each class.

The comparison circuit Cp compares the operation result with teacher data t. The operation result is an output value from the read-out layer 20. The teacher data t is an ideal value. The comparison circuit compares, for example, a difference in the mutual information between the operation result and the teacher data t. The mutual information is an amount representing a measure of interdependence of two probabilistic variables. When there are a plurality of outputs from the read-out layer 20 as in a multi-class classification problem, the comparison circuit compares respective output values with the probability distribution (teacher data t) for each class.

The comparison circuit Cp sends data D_{f} to the learner L so that the mutual information is increased (maximized), and the learner L changes the connection weight wⱼ on the basis of the data D_{f}. That is, the learning result in the comparison circuit Cp is feedback to the read-out layer (product-sum operation circuit). The connection weight wⱼ between each of the terminals 34 and the read-out layer 20 changes on the basis of the feedback data D_{f}. The connection weight wⱼ between each of the terminals 34 and the read-out layer 20 is adjusted so that the mutual information between the operation result and the teacher data t is increased (maximized). Note that when the aforementioned calculation is performed in advance, a weight obtained as a result of the calculation is reflected in the connection weight of the read-out layer 20, and the information processing device 100 is used exclusively for interference, the comparison circuit Cp may be omitted.

Next, a method for manufacturing the information processing device 100 will be described. First, the reservoir layer 10 and the read-out layer 20 are designed. As the reservoir layer 10 and the read-out layer 20, known technologies can be used. A physical device constituting the node 11 does not particularly matter. The reservoir layer 10 and the read-out layer 20 can be designed according to tasks given to the information processing device 100.

Next, a connection between the reservoir layer 10 and the read-out layer 20 is determined and the connection part 30 is formed. Specifically, it is determined whether to connect which node 11 of the reservoir layer 10 to the read-out layer 20. In other words, it is determined which of the nodes 11 are set as the hidden nodes 11A (if any). The connection between the reservoir layer 10 and the read-out layer 20 differs depending on tasks given to the information processing device 100. After the tasks given to the information processing device 100 are determined, one state is determined from innumerable connection states between the reservoir layer 10 and the read-out layer 20.

The method of setting the hidden nodes 11A has a first step of performing a prior examination and a second step of determining hidden nodes. The first step is performed using a reference information processing device 110. FIG. 3 is a conceptual diagram of the reference information processing device 110 according to the first embodiment.

The reference information processing device 110 includes a reference reservoir layer 50, a reference read-out layer 60, a connection part 70, a comparison circuit Cp, and a learner L. The reference information processing device 110 is different from the aforementioned information processing device 100 in that the connection part 70 is connected to all of nodes 51 of the reference reservoir layer 50 and all of the information is transmitted to the reference read-out layer 60.

The reference reservoir layer 50 has a plurality of nodes 51. Each of the nodes 51 has the same configuration as that of each of the nodes 11.

The number of nodes 51 is the same as the number of nodes 11. There are i nodes 51, for example. The i nodes 51 are all connected to the reference read-out layer 60 via the connection part 70. The number i of signals sent to the reference read-out layer 60 from the reference reservoir layer 50 matches the number i of nodes 51 in the reference reservoir layer 50.

The reference read-out layer 60 has the same configuration as that of the read-out layer 20.

In the first step, an operation using the reference information processing device 110 is performed. The reference information processing device 110 performs an operation so that the mutual information between an input value and an ideal value is increased (maximized), and determines connection weights wᵢ between the respective nodes 51 in the reference reservoir layer 50 and the reference read-out layer 60.

The operation of the first step may be performed by simulation, or may be performed by actually manufacturing a physical device.

First, signals Sᵢₙ are input to the reference reservoir layer 50. The number of input signals Sᵢₙ is the same as the number of signals Sᵢₙ input to the information processing device 100, for example. The input signals Sᵢₙ propagate in the reference reservoir layer 50, and the reference reservoir layer 50 generate a feature space including information of the input signals Sᵢₙ. Then, signals are sent to the reference read-out layer 60 from the respective nodes 51 in the reference reservoir layer 50 via the connection part 70.

The signals sent from the reference reservoir layer 50 are summed up after being multiplied by the connection weight wᵢ in a product-sum operation circuit of the reference read-out layer 60. The product-sum operation result is put into an activation function f(x).

Furthermore, the comparison circuit Cp compares the operation result with teacher data t. The comparison circuit Cp feedbacks data D_{f} to the product-sum operation circuit via the learner L so that the mutual information between the operation result and the teacher data is increased (maximized). The operation result is an output value from the reference read-out layer 60. The teacher data t is an ideal value. For example, the comparison circuit Cp compares the output value from the reference read-out layer 60 with the teacher data t, which is an ideal value, while changing a value corresponding to the connection weight wᵢ according to the data D_{f}. The comparison circuit Cp changes the connection weight wᵢ of the reference read-out layer 60 so as to take a value that increases the probability of matching the output value with the ideal value (increases the mutual information). Specifically, the comparison circuit Cp sets the connection of the connection part 70 (connection state of a wiring layer). The connection state of the wiring layer is, for example, wiring routing, wiring selection, a resistance value of the wiring layer, and the like.

The connection weight wᵢ is preferably determined by learning including norm regularization. For example, it is possible to use a regularization technique such as a norm minimization method or Group Lasso. A learning algorithm introducing a regularization term has an effect of making a distribution of weights sparse, and particularly, learning using Group Lasso is known to have an effect of making most of weights in a group zero. As a consequence, when setting a hidden node, it becomes easy to present a clear reference for a boundary between the hidden node and a node other than the hidden node.

Next, after the first step, the second step is performed. In the second step, nodes 51, which have a large influence on a signal Sₒᵤₜ output in the operation of the reference information processing device 110, and nodes 51, which have a small influence on the output signal Sₒᵤₜ, are classified.

In the first method, in the operation using the reference information processing device 110, the nodes 51 are classified on the basis of a result obtained by analyzing the variation amount of the plurality of nodes 51 by a statistical method.

The statistical method includes, for example, Fourier analysis, contribution rate of principal component analysis, nonlinear performance analysis, spectral radius, and the like. For example, nodes 51, which have high performance of nonlinearly converting the input signal Sᵢₙ, are classified as the nodes 51, which have a large influence on the signal Sₒᵤₜ output in the operation of the reference information processing device 110, and other nodes 51 are classified as the nodes 51 having a small influence on the output signal Sₒᵤₜ. Furthermore, for example, nodes to be connected to the read-out layer may be determined from the frequency characteristics of the state of each node 51 with respect to an input signal.

In the second method, the plurality of nodes 51 included in the reference information processing device 110 are classified on the basis of the statistic of connection weight vₓ with which each of the nodes 51 is connected to other nodes 51.

The statistic of the connection weight vₓ is, for example, the sum of connection weights vₓ between a reference node 51 and other nodes 51 connected to the reference node 51, the sum of connection weights vₓ between the reference node 51 and nodes 51 included within a predetermined radius around the reference node 51, and the like. Furthermore, for example, the nodes 51 may be classified by adjusting the spectral radii of all the nodes in the reservoir layer to be 0.5 or more and 1.0 or less.

For example, nodes 51, in which the statistic of the connection weights vₓ is equal to or greater than a predetermined value, are classified as the nodes 51, which have a large influence on the output signal Sₒᵤₜ, and nodes 51, in which the statistic of the connection weight vₓ is equal to or less than the predetermined value, are classified as the nodes 51 having a small influence on the output signal Sₒᵤₜ.

In the third method, the plurality of nodes 51 included in the reference information processing device 110 are classified on the basis of the absolute value of the connection weight wᵢ of the reference read-out layer 60.

For example, nodes 51, in which the absolute value of the connection weight wᵢ is equal to or greater than a predetermined value, are classified as the nodes 51, which have a large influence on the output signal Sₒᵤₜ, and nodes 51, in which the absolute value of the connection weight wᵢ is equal to or less than the predetermined value, are classified as the nodes 51 having a small influence on the output signal Sₒᵤₜ.

For a classification threshold, for example, a specific value may be set in advance. Furthermore, when a predetermined ratio of nodes 51 is set to be reduced among all the nodes 51, a statistic or an absolute value at the time when the predetermined ratio has reached may be used as the classification threshold.

The nodes 51, which have a small influence on the output signal Sₒᵤₜ, among the nodes 51 classified in the second step can be regarded as nodes that can be hidden nodes.

Next, based on the above results, the reservoir layer 10 and the read-out layer 20 are connected. Nodes 11 having the same positional relationship as the nodes 51, which can be hidden nodes in the reservoir layer 10, are not connected to the read-out layer 20, and the other nodes 11 are connected to the read-out layer 20. The nodes 11 not connected to the read-out layer 20 are hidden nodes 11A.

The reservoir layer 10 and the read-out layer 20 are connected in the above procedure, so that the information processing device 100 is manufactured.

In the information processing device 100 according to the first embodiment, not all the nodes 11 of the reservoir layer 10 are connected to the read-out layer 20, and the number of signals propagating to the read-out layer 20 is small. Consequently, the information processing device 100 can reduce an operation load.

Furthermore, when the number of signals propagating to the read-out layer 20 is small, the number of terminals 34 when being incorporated into a physical device can be reduced. By making the number of terminals 34 realistic, it is easy to apply reservoir computing to the physical device.

Furthermore, in the information processing device 100, although only information of a subspace of a feature space generated in the reservoir layer 10 is propagated to the read-out layer 20, an error between the case where all the nodes 11 of the reservoir layer 10 are connected to the read-out layer 20 and the output signal Sₒᵤₜ is small.

For example, a reservoir layer having 500 nodes was manufactured and connection weights of a read-out layer were learned.

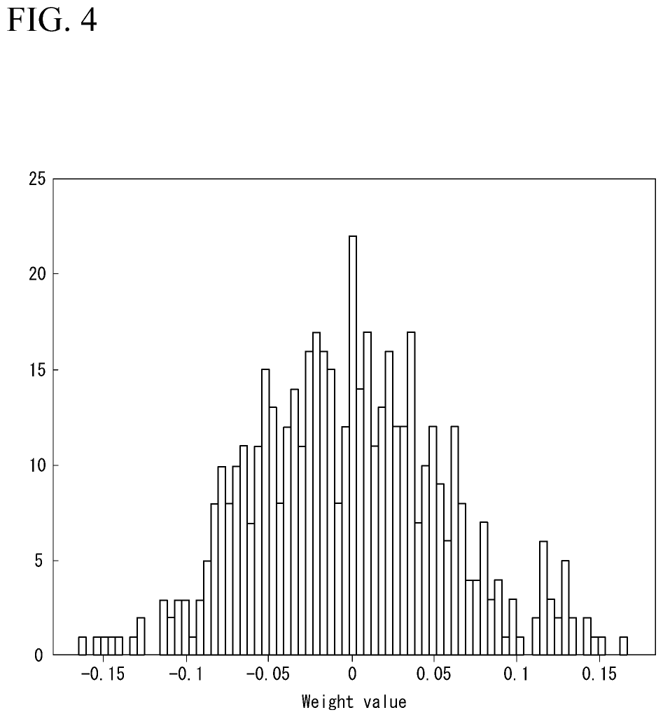

FIG. 4 shows a distribution of connection weights wᵢ between respective nodes and a read-out layer. A horizontal axis denotes the connection weights wᵢ between the respective nodes and the read-out layer, and a vertical axis denotes the number of wirings for which a predetermined connection weight wᵢ was set. FIG. 4 shows the distribution of the connection weights wᵢ when all the nodes and the read-out layer were connected. FIG. 4 also corresponds to the operation result using the reference information processing device 110.

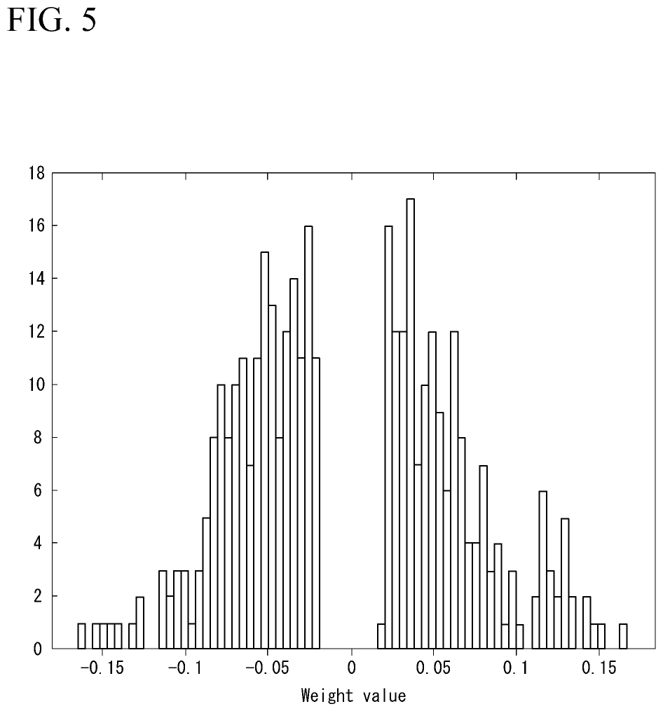

FIG. 5 shows a distribution of connection weights wⱼ between respective nodes and the read-out layer. A horizontal axis denotes the connection weights wⱼ between the respective nodes and the read-out layer, and a vertical axis denotes the number of wirings for which a predetermined connection weight wⱼ was set. FIG. 5 shows the distribution of the connection weights wⱼ when 168 (about 33%) nodes among the 500 nodes were not connected. The operation using the reference information processing device 110 was examined in advance and 33% of nodes were not connected to the read-out layer in order from nodes having the smallest connection weight wⱼ.

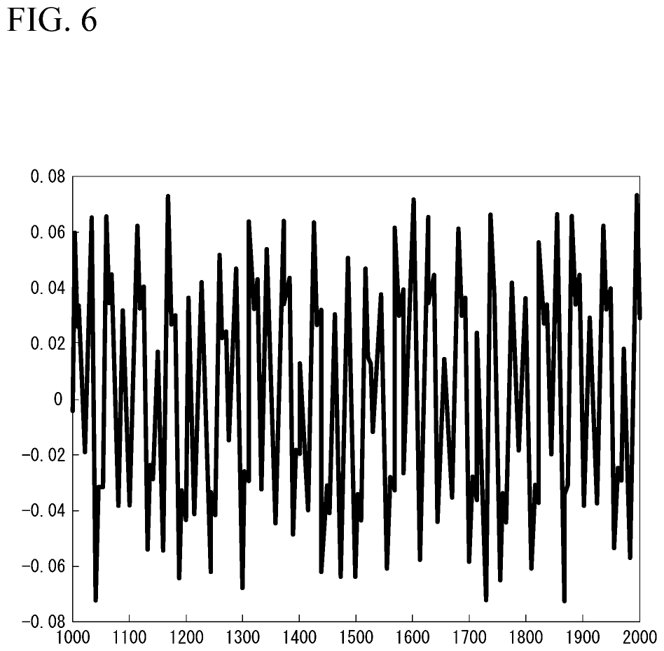

FIG. 6 shows a difference in output values between an inference result when all the nodes and the read-out layer were connected and an inference result when some nodes and the read-out layer were connected, in a prediction task of time-series signals. FIG. 6 shows a difference signal between an operation result when the distribution of the connection weights wᵢ between the nodes and the read-out layer was set to FIG. 4 and an operation result when the distribution of the connection weights wⱼ between the nodes and the read-out layer was set to FIG. 5. As shown in FIG. 6, an error between the two operation results was about 5% or less. That is, it can be said that the information processing device 100 has performance that can be sufficiently used as an actual device.

Furthermore, the same process was performed in another example. In the other example, in an operation when determining the connection weight wᵢ, regularization using norm minimization was performed. The norm minimization was such that L2 norm is minimized. The other conditions were the same as the above operation.

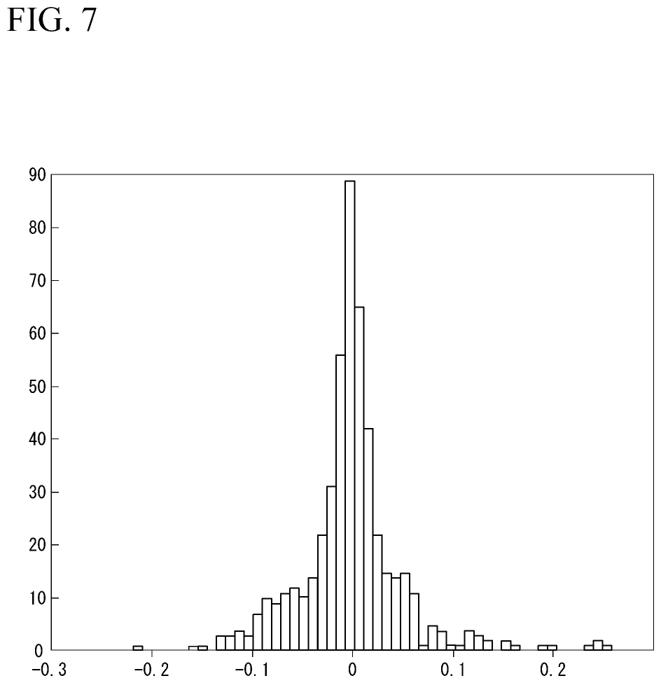

FIG. 7 shows a distribution of connection weights wᵢ between respective nodes and the read-out layer. A horizontal axis denotes the connection weights wᵢ between the respective nodes and the read-out layer, and a vertical axis denotes the number of wirings for which a predetermined connection weight wᵢ was set. FIG. 7 shows the distribution of the connection weights wᵢ when all the nodes and the read-out layer were connected. FIG. 7 also corresponds to the operation result using the reference information processing device 110. Since regularization using norm minimization was used for the learning operation of setting the connection weights wᵢ, the distribution of the connection weights wᵢ was sparse, and the number of wirings to be zero was larger than in the case of FIG. 4.

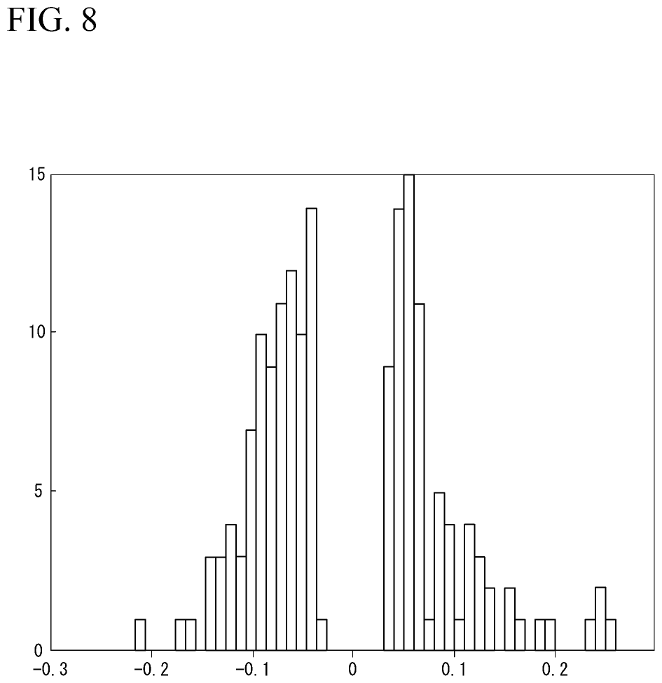

FIG. 8 shows a distribution of connection weights wⱼ between respective nodes and the read-out layer. A horizontal axis denotes the connection weights wⱼ between the respective nodes and the read-out layer, and a vertical axis denotes the number of wirings for which a predetermined connection weight wⱼ was set. FIG. 8 shows the distribution of the connection weights wⱼ when 136 (about 27%) nodes among the 500 nodes were not connected. The operation using the reference information processing device 110 was examined in advance and 27% of nodes were not connected to the read-out layer in order from nodes having the smallest connection weight wⱼ.

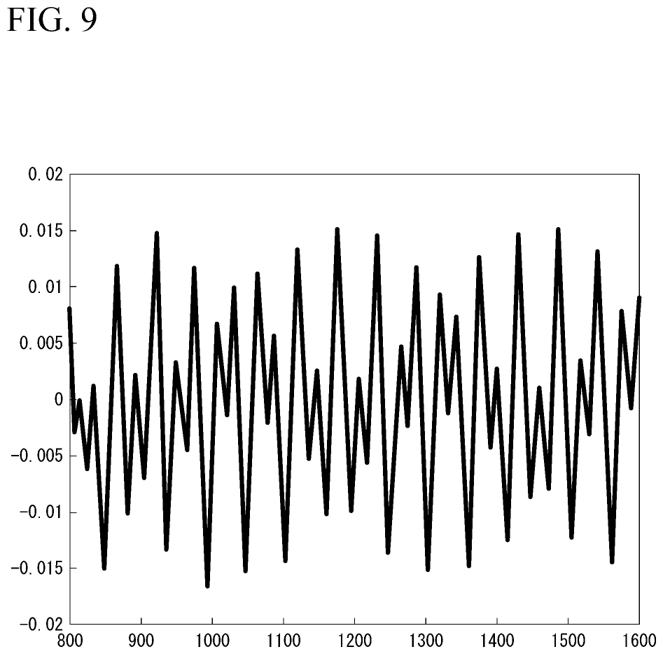

FIG. 9 shows a difference in output values between an inference result when all the nodes and the read-out layer were connected and an inference result when some nodes and the read-out layer were connected, in a prediction task of time-series signals. FIG. 9 shows a difference signal between an operation result when the distribution of the connection weights wᵢ between the nodes and the read-out layer was set to FIG. 7 and an operation result when the distribution of the connection weights wⱼ between the nodes and the read-out layer was set to FIG. 8. As shown in FIG. 9, an error between the two operation results was about 1% or less. That is, it can be said that the information processing device 100 has performance that can be sufficiently used as an actual device.

Although the embodiments of the present invention have been described in detail with reference to the drawings, the configurations, combinations thereof, and the like in the embodiments are examples, and addition, omission, replacement, and other modifications of configurations can be made without departing from the spirit of the present invention.

For example, as in an information processing device shown in FIG. 10, the connection part 30 may be configured to cover part of the reservoir layer 10 without covering the entire reservoir layer 10 when viewed from the z direction. Since the hidden nodes 11A do not need to be connected to the read-out layer 20, the connection part 30 may not be on the hidden nodes 11A.

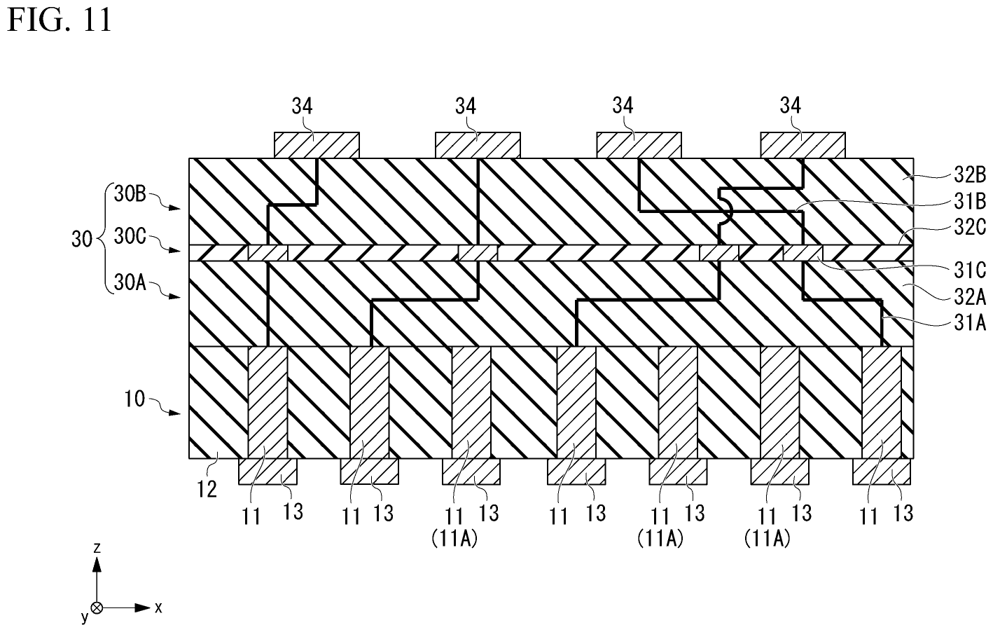

Furthermore, for example, as in an information processing device shown in FIG. 11, the connection part 30 may have a plurality of wiring layers 30A, 30B, and 30C. The wiring layer 30A has a plurality of wirings 31A and an insulating layer 32A. The wiring layer 30B has a plurality of wirings 31B and an insulating layer 32B. The wiring layer 30C has a plurality of wirings 31C and an insulating layer 32C. The connection part 30 is composed of the plurality of wiring layers 30A, 30B, and 30C, so that it is possible to implement more complicated wiring connections and wiring that satisfies process constraints.

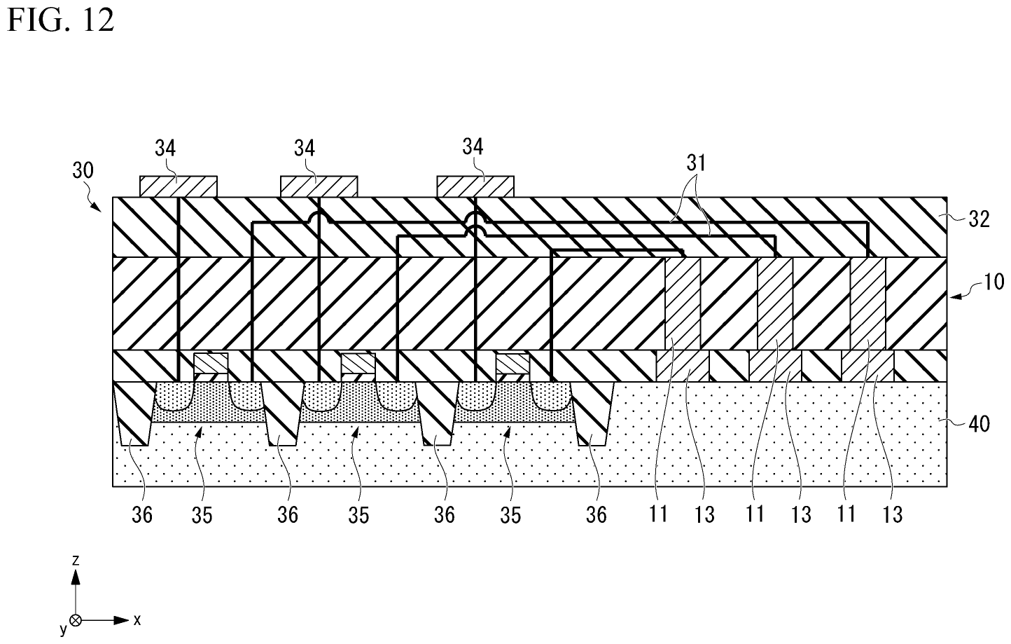

Furthermore, for example, as in an information processing device shown in FIG. 12, the connection part 30 may have switches. The switches are connected to output terminals of the nodes 11. The switches are, for example, transistors 35. There is an element isolation area 36 (shallow trench isolation (STI)) between the transistors 35. Sources of the respective transistors 35 are connected to the nodes 11, respectively. Drains of the respective transistors 35 are connected to the terminals 34, respectively.

When the connection part 30 has the switches as in the information processing device shown in FIG. 12, the number of terminals 34 may be the same as the number of nodes 11, or may be smaller than the number of nodes 11. When the number of terminals 34 is the same as the number of nodes 11, the number of signals sent from the reservoir layer 10 to the read-out layer 20 can be made smaller than the number of the plurality of nodes 11 by turning off some of the switches. The signal Sᵢₙ is input to each of the nodes 11 from the terminal 13. Nodes 11 connected to the turned-off transistors 35 are hidden nodes. The information processing device shown in FIG. 12 can switch hidden nodes according to a task by switching ON and OFF of the transistors 35. The connection information of each transistor can also be stored in a separately manufactured nonvolatile memory (not illustrated).

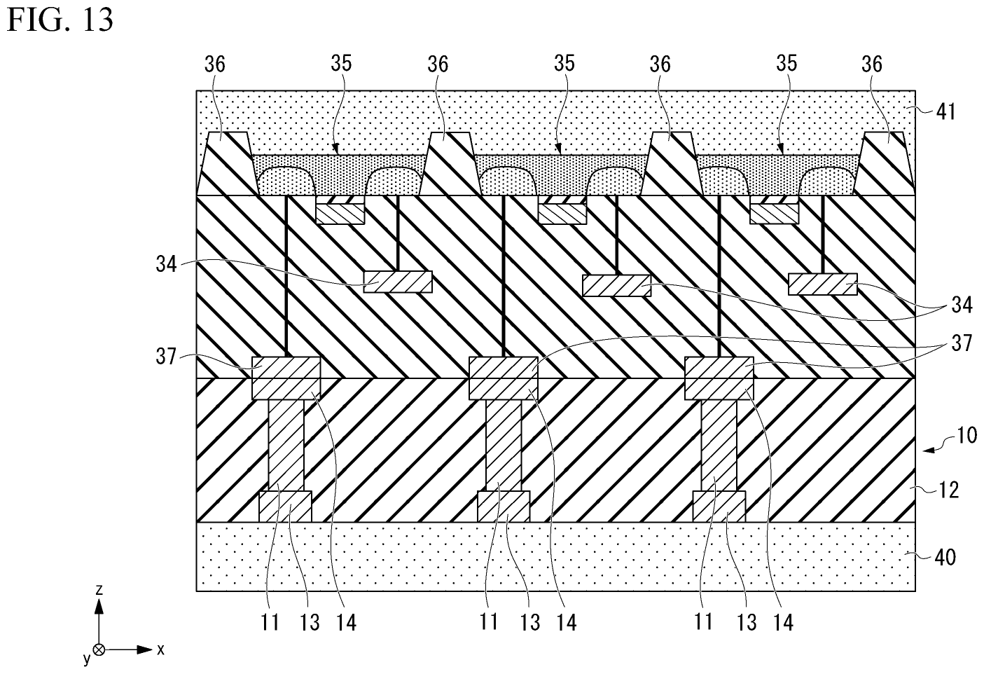

Furthermore, for example, as in an information processing device shown in FIG. 13, the connection part 30 may be attached to the reservoir layer 10. The reservoir layer 10 includes a first pad 14 connected to any one of the nodes 11. The connection part 30 includes a second pad 37 electrically connected to the terminal 34. The connection part 30 and the reservoir layer 10 are attached so that the first pad 14 and the second pad 37 match each other. The reservoir layer 10 and the connection part 30 are formed on different substrates 40 and 41 and are attached to each other after being manufactured.

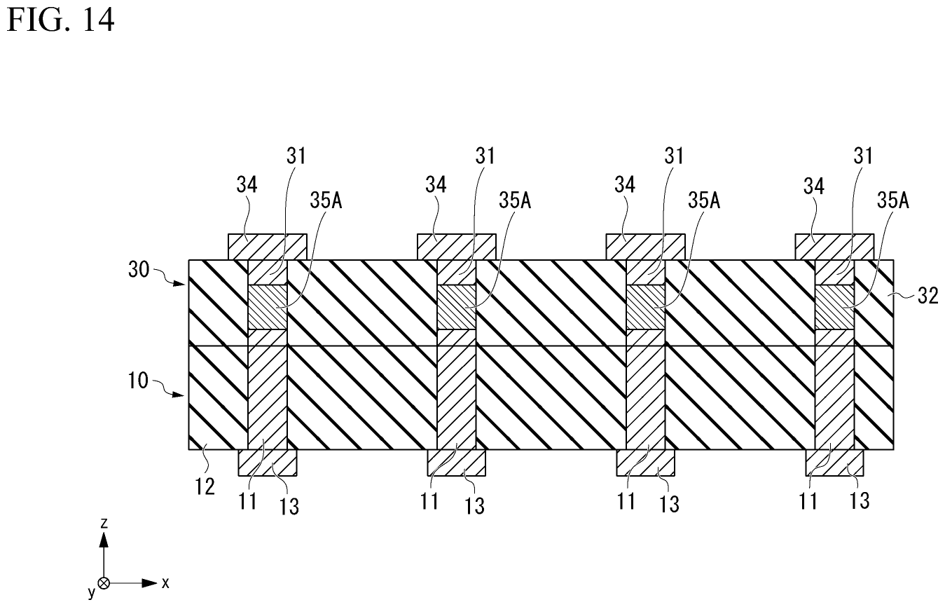

Furthermore, FIG. 12 and FIG. 13 illustrate an example in which the switch is the transistor 35; however, the switch is not limited to the transistor. Furthermore, as shown in FIG. 14, the switch may be a resistance-variable element 35A. The resistance-variable element 35A includes, for example, an element using the phase change of a crystal layer such as an ovonic threshold switch (OTS), an element using changes in a band structure such as a metal-insulator transition (MIT) switch, an element using a breakdown voltage such as a Zener diode and an avalanche diode, an element whose conductivity changes as an atomic position changes, a phase-change memory (PCM) whose resistance value changes with temperature changes, and the like. In the resistance-variable element 35A, an intermediate state can also be defined in addition to ON and OFF.

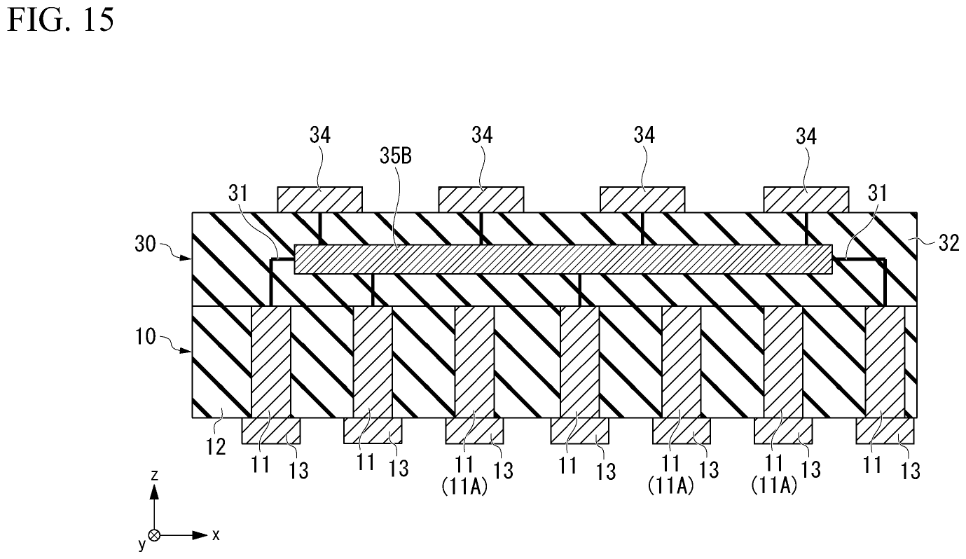

Furthermore, for example, as shown in FIG. 15, the switch may be a combinational circuit 35B. The combinational circuit 35B is an element or a device that switches the connection relationship between the node 11 and the terminal 34. The combinational circuit 35B is connected to the plurality of nodes 11 and the plurality of terminals 34. The combinational circuit 35B is, for example, a multiplexer. The combinational circuit 35B outputs, for example, other inputs from the plurality of nodes 11 to one terminal 34. Furthermore, the combinational circuit 35B can switch a terminal 34 which is an output destination.

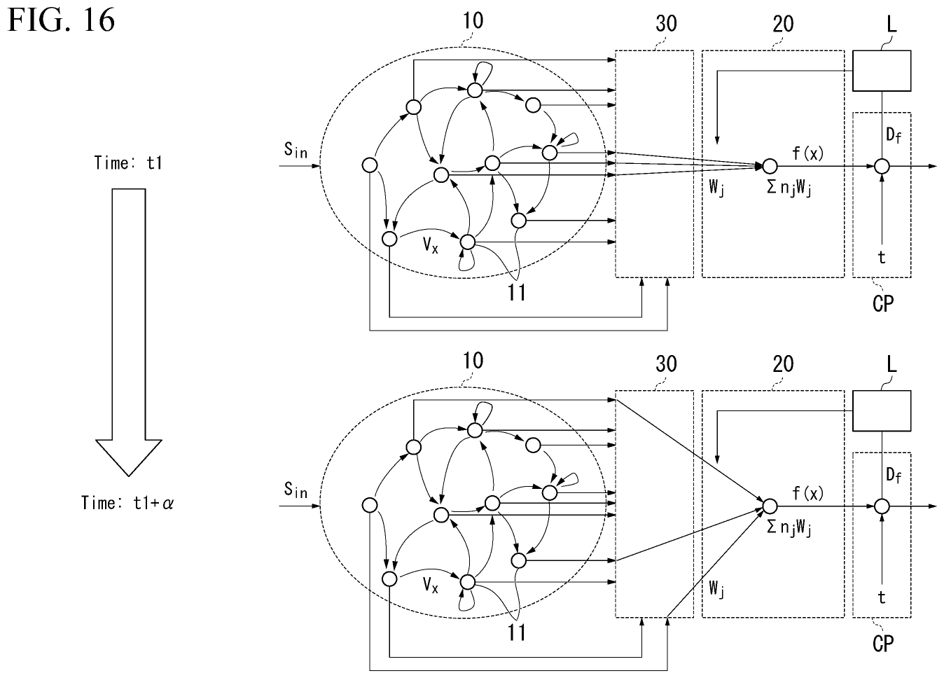

Furthermore, as shown in FIG. 16, when a switch is used, electrical connection between the plurality of nodes 11 and the read-out layer 20 may be switched over time. For example, the combinational circuit 35B shown in FIG. 15 may be used to switch the electrical connection between the node 11 and the terminal 34 for each time. When the electrical connection between the node 11 and the terminal 34 is switched, a node 11, which becomes the hidden node 11A, changes for each time. For example, at the time t1, the node 11 of a first group and the terminal 34 are connected and the node 11 other than the first group becomes the hidden node 11A, and at the time t1+α, the node 11 of a second group different from the first group and the terminal 34 are connected and the node 11 other than the second group becomes the hidden node 11A.

When the connection between the reservoir layer 10 and the read-out layer 20 changes over time, the information processing device 100 can process different tasks for each time. For example, the information processing device 100 can perform a first task that detects a first failure mode at a certain time t1 and a second task that detects a second failure mode at the time t1+α.

Furthermore, for example, as shown in FIG. 17, the reservoir layer 10 may have a plurality of node layers 11L stacked in the stack direction. Each of the plurality of node layers 11L has any one of a plurality of nodes 11. Part of the wirings 31 may be a through wiring 31S or a through wiring 31T that penetrates any one of the node layers 11L. The through wiring 31S connects any one of the plurality of terminals 34 and any one of the plurality of nodes 11. The through wiring 31T connects a switch (for example, the combinational circuit 35B) and any one of the plurality of nodes 11.

Furthermore, for example, as in an information processing device shown in FIG. 18, the connection part 30 may be on input sides of signals Sᵢₙ. The signals Sᵢₙ input from terminals 38 of the connection part 30 are sent to the nodes 11, respectively. Each of the terminals 38 is connected to an external sensor, for example. The connection part 30 transmits part of the signals from the sensors to the reservoir layer 10.

The number of terminals 38 is smaller than the number of nodes 11. The small number of terminals 38 relative to the nodes 11 facilitates the application of reservoir layer computing to a physical device.

Furthermore, the information processing device shown in FIG. 18 shows performance that can be sufficiently used as an actual device even though only part of the information detected by the sensors is used for generating a feature space in the reservoir layer 10.

The output circuit of the read-out layer can also be used as an auto encoder by connecting to a read-out layer of another information processing device having the same configuration. In such a case, the information processing device can also be used as a dimensional compressor or an authenticator.

### EXPLANATION OF REFERENCES

10 Reservoir layer
11, 51 Node
11A Hidden node
11L Node layer
12, 32, 32A, 32B, 32C Insulating layer
13, 34, 38 Terminal
14 First pad
20 Read-out layer
30, 70 Connection part
30A, 30B, 30C Wiring layer
31, 31A, 31B, 31C Wiring
31S, 31T Through wiring
35 Transistor
35A Resistance-variable element
35B Combinational circuit
36 Element isolation area
37 Second pad
40, 41 Substrate
50 Reference reservoir layer
60 Reference read-out layer
100 Information processing device
110 Reference information processing device

What is claimed is:

1. An information processing device comprising:
a reservoir layer; and
a read-out layer,
wherein the reservoir layer includes a plurality of nodes that generate a feature space including information of an input signal input to the reservoir layer,
the read-out layer performs an operation of applying a connection weight to each of signals sent from the reservoir layer, and
the number of signals sent to the read-out layer from the reservoir layer is smaller than the number of the plurality of nodes.

2. The information processing device according to claim 1, further comprising:
a connection part that connects the reservoir layer and the read-out layer,
wherein the connection part includes a plurality of terminals that connect any of the plurality of nodes to the read-out layer, and
the number of the plurality of terminals is smaller than the number of the plurality of nodes.

3. The information processing device according to claim 2, wherein the connection part includes a plurality of wirings, and
each of the plurality of wirings connects any one of the plurality of nodes to any one of the plurality of terminals.

4. The information processing device according to claim 2, wherein the connection part includes a switch, and
the switch switches electrical connection between the plurality of nodes and the plurality of terminals.

5. The information processing device according to claim 4, wherein the switch switches the electrical connection between the plurality of nodes and the plurality of terminals over time.

6. The information processing device according to claim 2, wherein the connection part is stacked on the reservoir layer and includes a plurality of wiring layers.

7. The information processing device according to claim 2, wherein the connection part is stacked on the reservoir layer and covers part of the reservoir layer when viewed from a stack direction.

8. The information processing device according to claim 2, wherein the reservoir layer includes a first pad connected to any one of the plurality of nodes, and
the connection part includes a second pad connected to any one of the plurality of terminals, and is attached to the reservoir layer via the first pad and the second pad.

9. The information processing device according to claim 1, wherein the plurality of nodes include a hidden node not connected to the read-out layer.

10. The information processing device according to claim 9, wherein the hidden node is determined on the basis of a result obtained by analyzing a variation amount of a plurality of nodes included in a reference information processing device by a statistical method in an operation using the reference information processing device,
the reference information processing device includes a reference reservoir layer having the same configuration as the reservoir layer and a reference read-out layer having the same configuration as the read-out layer,
the reference reservoir layer generates a feature space including information of input signals input to the reference reservoir layer, and
the reference read-out layer performs an operation of applying a connection weight to a signal sent from each node of the reference reservoir layer.

11. The information processing device according to claim 9, wherein the hidden node is determined on the basis of a statistic of a connection weight with which each of a plurality of nodes included in a reference information processing device is connected to other nodes,
the reference information processing device includes a reference reservoir layer having the same configuration as the reservoir layer and a reference read-out layer having the same configuration as the read-out layer,
the reference reservoir layer generates a feature space including information of input signals input to the reference reservoir layer, and
the reference read-out layer performs an operation of applying a connection weight to a signal sent from each node of the reference reservoir layer.

12. The information processing device according to claim 9, wherein the hidden node is determined on the basis of an absolute value of a connection weight with which each of a plurality of nodes included in a reference information processing device is connected to a reference read-out layer,
the reference information processing device includes a reference reservoir layer having the same configuration as the reservoir layer and a reference read-out layer having the same configuration as the read-out layer,
the reference reservoir layer generates a feature space including information of input signals input to the reference reservoir layer, and
the reference read-out layer performs an operation of applying a connection weight to a signal sent from each node of the reference reservoir layer.

13. The information processing device according to claim 12, wherein a connection weight between the plurality of nodes of the reference reservoir layer and the reference read-out layer is determined by learning including norm regularization.

14. The information processing device according to claim 2, wherein the reservoir layer has a plurality of node layers stacked in a stack direction,
each of the plurality of node layers has any one of the plurality of nodes, and
the connection part further includes a through wiring that connects any one of the plurality of terminals and any one of the plurality of nodes, and penetrates any one of the plurality of node layers.

15. An information processing device comprising:
a reservoir layer; and
a read-out layer,
wherein the reservoir layer includes a plurality of nodes that generate a feature space including information of an input signal input to the reservoir layer,
the read-out layer performs an operation of applying a connection weight to each of signals sent from the reservoir layer, and
the number of input terminals, to which the input signal is input, is smaller than the number of the plurality of nodes.

16. A method for setting hidden nodes, the method comprising:
a first step of performing a prior examination; and
a second step of determining the hidden nodes,
wherein the first step is performed using a reference information processing device including a reference reservoir layer and a reference read-out layer,
the reference information processing device generates a feature space including information of input signals in the reference reservoir layer, applies a connection weight to a signal sent from each of nodes of the reference reservoir layer to the reference read-out layer, and performs an operation of increasing a mutual information between an output value from the reference read-out layer and an ideal value, and
in the second step, on the basis of a connection weight between the nodes in the reference reservoir layer after the operation in the first step, or a connection weight between the nodes in the reference reservoir layer and the reference read-out layer, it is determined whether to set which of a plurality of nodes included in the reference reservoir layer as the hidden nodes.

17. A method for manufacturing an information processing device, the method comprising:
a step of designing a reservoir layer and a read-out layer connectable to the reservoir layer;
a step of performing the method for setting hidden nodes according to claim 16 by using a reference reservoir layer having the same configuration as the reservoir layer, and setting the hidden nodes in the reservoir layer; and
a step of connecting nodes, other than the hidden nodes among a plurality of nodes included in the reservoir layer, to the read-out layer.
